(19) United States
(12) Patent Application Publication
(10) Pub. No.: US 2026/0280302 A1
(43) Pub. Date: Sep. 17, 2026

(54) CHARGING MANAGEMENT SYSTEM FOR ELECTRIC VEHICLES

(71) Applicant: SMART ENERGY LAB – ASSOCIATION, Lisboa (PT)

(72) Inventors: Diogo BRITO, Amadora (PT); João CRESPO, Marinha Grande (PT); Filipe SARAIVA SANTOS, Lisboa (PT); Pedro GEIRINHAS ROCHA, Linda A Velha (PT); Oluwapelumi EGUNJOBI, Condeixa-a-nova (PT)

(21) Appl. No.: 19/474,213

(22) PCT Filed: Aug. 31, 2023
(86) PCT No.: PCT/IB2023/058624

§ 371 Date: Oct. 10, 2025

(30) Foreign Application Priority Data
Apr. 12, 2023 (PT) 118600

(51) Int. Cl. H02J 3/32; B60L 53/62; B60L 53/63; B60L 53/68; H02J 3/38; H02J 13/12; H02J 101/24

(52) U.S. Cl. CPC H02J 3/322; B60L 53/62; B60L 53/63; B60L 53/68; H02J 3/38; H02J 13/12; H02J 2101/24

(57) ABSTRACT

A charging management system for electric vehicles that tackles the main identified current challenges in shared parking spaces, including limited power availability, absence of charging management or billing settlement, grid limitations and non-standard installation processes. The system enables reducing the number of isolated proprietary electrical boards and stakeholders involved in the adaptation, while avoiding power supply upscaling, by centralizing multiple Distributed Energy Resources (DER) into a common electrical board, enabling their monitoring and control to avoid surpassing power limits of the supplying infrastructure and/or, additionally, provide grid services. It also provides a local management system for multiple proprietary charging points, or other Distributed Energy Resources, simplifying on-site installation, ensuring regulatory standards compliance, and in a scalable manner, allowing a modular adaptation to the progressive increase of DER users, deploying common DERs to increase the EV charging infrastructure capabilities or respond to future grid constraint needs.

### TECHNICAL FIELD

The present application describes a charging management system for electric vehicles.

### BACKGROUND ART

Climate changes and global warming are occurring at an unprecedented rate, and human activity is the principal cause. These effects are stimulating a global transition in the energy sector from fossil-based systems of energy production and consumption to renewable energy sources (RES), as a commitment to achieve the needed decarbonization. This energy transition is speeding up the global electrical vehicle adoption and micro-renewables resources, which are imposing several challenges for adapting the existing electrical infrastructures.

Electric Vehicles (EV) adoption and massification will only be possible if accompanied by an increase in charging point availability and ease of use, which can only be driven by a fast-to-develop and deployable charging infrastructure, being this the aim of the proposed invention. Additionally, a large portion of EV cars are parked in shared parking spaces (in their condominiums and workplaces) and currently do not have an individual charging solution, while studies reveal a large demand for it. Currently, the number of charging points in these environments is still reduced, due to the increased difficulty to adapt the shared park electrical infrastructure to cope with the required power capacity, being one of the major causes of the reduction of the EV adoption rate by end users.

In brief, there are five levels of capacity limitation to widespread adoption of individual EV charging systems: 1) limited availability of electric power in the distribution grid; 2) internal grid infrastructure of condominiums and workplaces were not designed to handle required capacity for EV charging; 3) required telecommunication infrastructure to support EV management systems are lacking or limited; 4) there is a sustained shortage of skilled labor to deploy existing charging systems; 5) cloud infrastructure in which most charging systems rely on, is becoming saturated and efficient management will require edge computing capabilities.

### SUMMARY

The present invention describes a system for managing the distributed electrical power resources of an electrical infrastructure including vehicle charging systems, comprising a HUB connected to a Common Services Electrical Board by means of electrical wiring and MODBUS RTU/TCP communication protocols, and to a cloud platform by means of a TCP/IP communication protocol; wherein the HUB is configured to monitor and limit distributed electrical power resources, avoiding upscaling of the electrical infrastructure, enabling the reduction of asset interconnections to said HUB through the centralization of said distributed electrical power resources in a scalable manner, said assets comprising at least one isolated proprietary electrical board for charging electrical vehicles and/or an electrical power inverter and/or an electrical distributed energy resource.

In a proposed embodiment of present invention, the Common Services Electrical Board comprises at least of a measuring unit and a main board; the measuring unit being configured to measure electrical quantities and/or grid quality metrics.

Yet in another proposed embodiment of present invention, the HUB comprises at least a mobile communications module, a main control module and a set of connection modules, said control module being configured to monitor the electrical power resources supplied by the Common Services Electrical Board composed by managed and unmanaged electrical loads, and to ensure the connectivity to the cloud platform, managing to log a HUB system state in a remote database therein comprised, providing to an end-user and to a platform manager the charging state of the vehicle charging system and any occurring system error.

Yet in another proposed embodiment of present invention, the HUB is configured to enable mobile data communications and ease of power connectivity and enable both remote and local control management for all the electrically connected assets through dedicated connections provided by the set of independent Connection Modules.

Yet in another proposed embodiment of present invention, the Connection Modules comprise multiple physical interfaces to cope with a multiplicity of assets and multiple open or custom communications protocols and the required conformity electrical protections.

Yet in another proposed embodiment of present invention, the Connection Modules comprise at least one of an overcurrent protection device and/or a residual current device and/or measuring unit and/or communications unit and/or a contactor, said contactor enabling an electric load management provided to the assets when in absence of other means of control.

Yet in another proposed embodiment of present invention, the isolated proprietary electrical board for charging electrical vehicles comprises at least one of a mode 2 EV chargers and/or mode 3 EV chargers and/or mode 4 EV chargers. Yet in another proposed embodiment of present invention, the electrical power inverter comprises at least one of an electric micro-generation system, battery system and/or vehicle-to-grid systems.

Yet in another proposed embodiment of present invention, the Connection Modules are configured to operate in accordance with a firmware module further comprised of multiple modules that enable communications, operation and supervision of the assets thereto connected.

Yet in another proposed embodiment of present invention, the HUB is configured to communicate with a remote server, independent Connection Modules, and deploy local algorithms, firmware updates, and further engage the connectivity and scalability to adjacent HUBS.

Yet in another proposed embodiment of present invention, the main control module is configured to operate in accordance with a firmware setting comprised of at least one of a Data Bus and Control Interface firmware module, a System firmware module, a HUB firmware module and an Open Charge Point Protocol firmware module, the HUB firmware module being configured to enable an asset management algorithm module comprising smart charging and load balancing algorithm module that manages the maximum admissible electrical power delivered to each isolated proprietary electrical board.

Yet in another proposed embodiment of present invention, the smart charging and load balancing algorithm module comprises at least one of a set of time-based FIFO settings module, an Energy-based FIFO settings module, and a mixed smart charging settings module, wherein the time-based FIFO settings module is configured to suspend the electrical power supply to a required number of isolated proprietary electrical boards, enabling the overall electrical infrastructure load to an allowable electrical power level while iterating the enablement of said isolated proprietary electrical boards in a first-in-first-out time-based management procedure, splitting the electrical power supply into equal time fractions; the energy-based FIFO Settings module is configured to suspend the electrical power supply to a required number of isolated proprietary electrical boards, enabling the overall electrical infrastructure load to an allowable electrical power level while iterating the enablement of said isolated proprietary electrical boards in a first-in-first-out energy-based management procedure, splitting the electrical power supply into equal energy fractions; and the mixed smart charging settings module is configured to suspend the electrical power supply or reduce or increase the power to a required number of isolated proprietary electrical boards, enabling to maintain overall electrical infrastructure load to an allowable electrical power level while iterating the enablement of said isolated proprietary electrical boards in a variable time and power based management procedures, splitting the both the time and varying the electrical power supply into variable energy fractions while ensuring a maximum admissible power of the electrical infrastructure.

Yet in another proposed embodiment of present invention, the HUB is structurally configured to allow the individual access to the mobile communications module, the main control module, the connection modules, and/or other modules therein enclosed, by technical installers through differentiated access level means.

### GENERAL DESCRIPTION

The ongoing Energy and Climate global strategy triggered a large electrical transition among all the sectors. The adoption and acceleration of the usage of electric vehicles, photovoltaics (PVs), batteries, heat pumps, and other distributed energy resources will require a power upscale process, which relies on extensive electrical infrastructure adaptations, which are complex, costly, not yet standardized, and can take decades until a massification is reached.

To deploy these massively charging infrastructures for electric vehicles, three main challenges were identified:

### 1. LIMITED CAPACITY

1.1. The Maximum Admissible Power (MAP) installed in shared parking spaces imposes a limitation on the number of simultaneously available charging points and/or the maximum charging power of each one. Additionally, it is known that to increase the MAP value, the building/park owner, the EV user, the Distribution System Operator (DSO), and the electrical energy provider will incur in high costs to change the electrical infrastructure, oftentimes the internal building infrastructure as well as the distribution network infrastructure, and will involve the agreement of multiple stakeholders, which adds more time and complexity to the process, thus reducing the chances of having many installations in a short period.
1.2. Currently, the existing systems that manage the EV charging loads to avoid surpassing the MAP, thus changing the infrastructure, are only supporting mode 3 EV chargers and mode 4 EV chargers (direct plug to a charging wall box) with control capabilities over Open Charge Point Protocol (OCPP) or proprietary protocols. However, the majority of EV users only have mode 2 EV chargers (direct plug to the electrical infrastructure) available, being this the preferred mode of charging for plug-in hybrid electric vehicles (PHEVs), which are expected to become a large portion of the EV fleet worldwide in the upcoming years.
1.3. Photovoltaics (PV) and other renewables are being deployed at an increasing rate and are already being limited due to grid constraints since most of the grid is outdated and was not designed to cope with the increase in import/export power. This can be mitigated by adding a combined control to the renewable and/or by managing loads that can be optimized to minimize the impact of these deployed assets in the grid or even be used to deploy use cases related to flexibility services. Additionally, the current Distributed Energy Resource (DER) systems being deployed have limited monitor and control capabilities, and, if enabled and combined with E-mobility, allow further savings to the end client, and potential benefits to Grid Operators.
1.4. The current telecommunication networks are deployed in 3G/4G/5G technologies, which are dependent on the installation location, network load usage and environmental factors, which can hinder the scalability of the solution due to increased latency and bandwidth.
1.5. Additionally, with the exponential increase of connected devices, cloud availability and load may also become limited in the near future.

### 2. CHARGING MANAGEMENT

2.1. Charging point management systems are commonly deployed remotely, requiring additional communication interfaces per charging point, increasing the complexity and costs of charging stations. In addition, the remote control reduces the reaction time of the system, increases fault probabilities and, in extreme cases, it can also reduce the charging point availability (in case of communication failure, it may not be possible to charge).
2.2. Charging point management are the means of mitigating power limitations. These limitations, appear both from infrastructure, energy/power tariffs, which although simple arithmetic operations may resolve, may require real-time monitoring: of energy consumption, power instantaneous or averaged over periods; tariffs which may be static or indexed; and additionally, the energy markets are evolving with the DER massification, and the future of the billing schemes/market rules/business models is still uncertain. Current systems are not prepared or flexible enough to be adapted to these future needs.
2.3. Mode 2 EV chargers (plugs) do not have a built-in local management solution but are the most common chargers made available with the sold EV cars. Although charging at reduced power, the increase in their dissemination will require efficient management, additionally, information regarding the charging session is commonly not available, or only via the manufacturer cloud, but the majority of them only use closed protocols, hindering the access to this information from outside entities.

### 3. SEAMLESS EV USER EXPERIENCE

3.1. EV users buying an EV charging solution typically need to acquire an understanding of the existing infrastructure where the solution will be installed. This involves knowledge about capacity limitations, any prior systems in place, rules and additionally when in community environments (like condominiums), ensuring equality among community members as part of the process and enforce added functionalities dissemination across all users while being independent of the number of users. The current processes for this are difficult, since several non-standard solutions are being installed ad-hoc, and most of the times are not directly compatible, also not backward compatible with pre-existing charging systems, and enabling compatibility requires custom and complex solutions which the ordinary EV user or the Park manager may not find themselves in a position able to decide.
3.2. On-site, commonly there is a central grid distribution point, with one associated electricity contract and meter, which increases the difficulty of the billing settlement process when it is required to share this point to many assets (EVs and/or others), especially when in presence of multi-period tariffs or even worse when indexed tariffs. This increases the resistance to adopting these systems, since it is difficult to obtain an understanding and agreement between all the involved parties (i.e. the contract owner and the EV user).
3.3. Existing installations are not standardized. Commonly, installers connect the chargers directly to the Common Services Electrical Board (CSEB) or in some instances directly to a junction box, following unsupervised conformity measures, which may not be fully regulation compliant. This increases the person safety risks and may lead to permanent damages to the equipment and infrastructures, which hinders the EV user to have a clear understanding while selecting an EV charging solution, and also the installation equality for all the EV chargers installations.
3.4. Proper electrical installation of charging infrastructures, commonly rely on specialized or highly skilled technical electricians, which are limited in numbers, thus reducing the chances of mass deployment of charging solutions.

Additionally, the proposed architecture enables cloud and local processing, providing the flexibility for the system to respond to future and still unforeseen requirements, such as energy markets evolution due to the massification of DERs, where the tariffs schemes, market rules and business models will change in the near future, and even today they are region dependent, requiring product customizations to adapt to the countries specific regulations. Furthermore, technology will also evolve, as well as new monitoring and control protocols to manage the assets will appear, and the invention allows its addition by including software/firmware modules to support these new features. Moreover, having a local controller allows reduce the cloud-edge interactions to the minimum required for monitoring, and or share the necessary parameters for the use-case control algorithms delivery.

Generally, the proposed invention manages a set of entry parameters (infrastructure, tariffs, control logic). The control logic algorithms are simple arithmetic operations that can be managed locally (if required in real-time operation), which allows to respond to the identified uncertainty regarding the future use-cases requirements.

Considering the limitations of the existing infrastructures, the present invention provides a short-term solution that avoids the immediate electrical infrastructure adaptation by bundling the required core communications, means of control the DERs and the electrical connectivity, allowing a modular expansion for future needs.

The disclosed invention was engineered for shared parking spaces (entry point) that have the need to manage their EV infrastructure, being technically suitable for condominiums/multi-family homes/multi-family dwellings, offices and commercial buildings, where it can be installed as an Energy Management System (EMS), including several services:
i) EV charging;
ii) Solar production;
iii) Energy storage; and
iv) Central Heating/Cooling systems.

The solution can be deployed together with Renewable Energy Communities (RECs) to enable maximization of RES use for EV charging in condominiums/multi-family homes/multi-family dwellings, offices and commercial buildings. Because of the considerable size of load expected in condominiums/multi-family homes/multi-family dwellings, offices and commercial buildings, it can also be an enabler to provide energy system services (e.g. primary frequency response; regulation, contingency spinning, replacement/supplement, ramping/load following).

The herein disclosed technology is composed by two main block units:
COMMUNICATIONS AND CONTROL HUB: This is the central structure of the developed system, and being the core of the hardware solution, is configured to enable mobile data communication, ease of power connectivity, enabling both remote (cloud) and local control (edge) management for all the electrically connected assets through the installable independent Connection Modules (CM). A firmware is deployed on a local controller and is comprised of multiple modules to supervise the running system of the connected assets, communicate with a remote server and deploy local algorithms.
CONNECTION MODULE: These custom-built modules are interconnected with main control HUB and are configured to facilitate the introduction and connectivity of new assets in the charging system and is built with different versions according to the required electrical protection standards, measurement needs, and required control mechanisms depending on the type of asset. Overall, it is adapted and configured to allow the interconnection of the HUB and the DERs (i.e. Electrical Vehicles chargers, inverters). The Connection Modules are built to offer multiple physical interfaces, to cope with the diversity of possible existing assets, and multiple open or custom communications protocols. Also allowing the scale of the system granularly, since the system can be initially installed with a single connection module, and new connection modules added afterwards depending on the end-user needs.

The overall system is configured on a software structure basis, comprising the use of remote servers and a front-end application configured to allow users and park managers to monitor and control charging sessions and expenses. The present invention provides a solution to reduce the number of isolated proprietary electrical boards and stakeholders involved in the adaptation, and also avoiding the power upscale of the building, by centralizing multiple Distributed Energy Resources (DER) connections into a common centralized electrical board, which enables the monitoring and control of them to avoid surpassing the power limit of the supplying infrastructure and/or, additionally, provide grid services (i.e., demand response, flexibility), enabling, also, the contribution to an improvement of the overall grid supply quality. It also provides a local management solution for multiple charging points and/or other Distributed Energy Resources (DER), which facilitates on-site installation and in a scalable manner, allowing to adapt to the progressive increase of DER users and/or deploy common DERs to increase the EV charging infrastructure capabilities in terms of power or energy cost reduction, reducing deployment and installation duration and complexity. The disclosed technical solution supports simultaneously mode 2 (plugs), mode 3 EV chargers (wall boxes) and mode 4 EV chargers (DC wall boxes) and enables the support for the inclusion of micro-generation renewables, batteries, and vehicle-to-grid (V2G), including the possibility of remote macro management for electrical grid management and optimization. The overall EV charging solution was designed to break the state-of-the-art limitations, by reducing the number of proprietary electrical charging boards to one single and central unit, the HUB, facilitating and standardizing the installation procedure and reducing the required number of interconnections, while maintaining existing systems' functionalities and enabling new ones. In addition, it enables the control of a multitude of assets for grid import/export management purposes. The control actions can be operated remotely, locally, on-demand, or autonomously following the deployed algorithms.

### BRIEF DESCRIPTION OF THE DRAWINGS

For better understanding of the present application, figures representing preferred embodiments are herein attached which, however, are not intended to limit the technique disclosed herein.

FIG. 1—illustrates an overall hardware block diagram of the developed system wherein the reference numbers relate to: 1—end-assets, i.e., electrical vehicle (EV) ; 2—photovoltaic system; 3-battery bank; 10—Wall box/mode 3 EV charger; 20—Plug/mode 2 EV chargers; 30—Wall box V2X/mode 4 EV chargers; 40—Photovoltaics (PV) inverter; 50-Battery inverter; 100—HUB; 101—mobile communications module; 102—Main control module; 103—Connection Modules 1 to n: CM1, CM2, CM3, CM4, CM5, CMn; 200—Distribution System Operator (DSO); 300—Cloud Platform/server; 400—Common Services Electrical Board (CSEB); 401—CSEB measuring unit; 402—CSEB Main Board; 500—MODBUS RTU/TCP communication protocol; 501—OCPP 2.0 protocol; 502—OCPP 1.6 protocol; 503—TCP/IP communication protocol; 504—Grid connection; 601—unidirectional power supply; 602—bidirectional power supply.

FIG. 2—illustrates the Main Control Module (102) Data Bus and Control Interface Firmware Diagram wherein the reference numbers relate to: 500—MODBUS RTU/TCP communication protocol; 505—digital Inputs/Outputs; 506—controller; 507—data bus and control interface.

FIG. 3—illustrates an overall Main Control Module (102) System Firmware Diagram, wherein the references relate to: 507—data bus and control interface; 508—instance and parameter bus; 509—parameters and environments; 510—store; 511—logs and errors; 512—system.

FIG. 4—illustrates an overall Main Control Module (102) HUB Firmware Diagram, wherein the references relate to: 100—HUB; 507—data bus and control interface; 513—data manager; 514—firmware update; 515—algorithm; 516—Supervision; 517—asset management algorithm module.

FIG. 5—illustrates the Main Control Module (102) Open Charge Point Protocol (OCPP) Firmware Diagram, wherein the references relate to: 518—OCPP Validation and Formats; 519—Client; 520—Server; 521—OCPP.

FIG. 6—illustrates an overall Time-based FIFO Functional Example for two Charging Points (CP), or assets, wherein the references relate to: 1001—¼ MAP; 1002—½ MAP; 1003—¾ MAP; 1004—MAP; 1005—MAP units in Watts; 1006—time in minutes; 1010—waiting time slot; 1011—no power limitation slot; 1020—CP1 ON; 1021—CP2 ON; 1030—CP1 charging power in Watts; 1031—CP2 charging power in Watts; 1032—Available power.

FIG. 7—illustrates an Energy-based FIFO Functional Example for two Charging Points (CP), or assets, wherein the references relate to: 1001-¼ MAP; 1002—½ MAP; 1003—¾ MAP; 1004—MAP; 1005—MAP units in Watts; 1006—time in minutes; 1012—CP2 Charged for 1 kWh; 1013—CP1 Charged for 1 kWh; 1015—No power limitation; 1020—CP1 ON; 1021—CP2 ON; 1030—CP1 charging power in Watts; 1031—CP2 charging power in Watts; 1032—Available power;

FIG. 8—illustrates a Mixed Smart Charging Functional Example for two Charging Points (CP), or assets, wherein the references relate to: 1001—¼ MAP; 1002—½ MAP; 1003—¾ MAP; 1004—MAP; 1005—MAP units in Watts; 1006—time in minutes; 1012—CP2 Charged for 1 kWh; 1013—CP1 Charged for 1 kWh; 1014—Smart/adaptable Charging; 1015—No power limitation; 1020—CP1 ON; 10201—½ CP1 power ON; 10202—3/4 CP1 power ON; 1021—CP2 ON; 1030—CP1 charging power in Watts; 1031—CP2 charging power in Watts; 1032—Available power.

FIG. 9—illustrates a connection module (CM2) that controls a mode 2 EV charger (20), wherein the references relate to: OCPD—overcurrent protection device; RCD—Residual-Current Device; Wh—energy meter/wattmeter; Cont—contactor; Phy—physical interface; 500—MODBUS RTU/TCP communication protocol; 503—TCP/IP communication protocol; 601—unidirectional power supply.

FIG. 10—illustrates an overall representation of a possible embodiment of the HUB (100), where the reference numbers relate to: 101—mobile communications module; 102—Main control module; 1021—-charging point (CP) installer compartment; 1022—Main Installer Compartment; 103—Connection Module; 1031-Connection Module Placeholder.

FIG. 11—illustrates a first overall representation of a possible embodiment of a connection module (103), in a front-view perspective, where the following references relate to: OCPD—overcurrent protection device; RCD—Residual-Current Device; Wh—energy meter/wattmeter; Cont—contactor; Phy—physical interface.

FIG. 12—illustrates a second overall representation of another possible embodiment of the connection module (103), in a rear-view perspective, where the reference numbers relate to: 1031—power plug; 1032—communications plug; 1033—snap fit.

### DESCRIPTION OF EMBODIMENTS

With reference to the figures, some embodiments are now described in more detail, which are however not intended to limit the scope of the present application.

The present disclosed invention provides a solution to reduce the number of proprietary electrical boards for charging electrical vehicles. The technical solution acts in three locations of the end-user electrical infrastructure:
the grid point, e.g., a shared parking space which is usually electrically supplied by the Common Services Electrical Board (400) of the building;
a partial distribution board, i.e., the HUB (100); and
the assets, i.e., the EV chargers (10, 20, 30), as depicted in FIG. 1, where an example of installation of the solution is presented.

The HUB (100), which is a customizable electrical board, is installed behind the DSO (200) meter and in dependency of the Common Services Electrical Board (400) of the building, is designed and configured to allow the standardization of EV charging solutions and electrical facilities, while serving as base electrical board for the installation of connection modules configured for different distributed energy resources. The HUB (100), as depicted in FIG. 1, is supplied by the Common Services Electrical Board (400) and connected using MODBUS communication protocol (500) to a herein installed energy meter or DSO meter (using a HAN Port -Home Area Network Port), CSEB measuring unit (401), for monitoring the total consumed power. The Common Services Electrical Board (400) comprises at least an energy measuring unit (401) and the mandatory conformity electrical protections to electrically connect the HUB (100). The Common Services Electrical Board (401) is composed by managed and unmanaged electrical loads, by reading the energy measuring unit and to ensure the connectivity to the cloud platform (300), managing to log a HUB system (100) and connected assets states in a remote database therein comprised, providing to an end-user the charging state of the vehicle charging system and to a platform manager the system state and any occurring system error.

The HUB (100) is configured to manage multiple types of assets (10, 20, 30, 40, 50) by means of a main controller module (102), which monitors the energy/power consumption supplied by the Common Services Electrical Board (400), that contains managed and unmanaged loads. The main controller module (102) ensures the connectivity to a cloud server platform (300) via an internet protocol (503), managing to log the system state (100) in a remote database, enabling visibility to an end-user of the end-assets (1, 2, 3) state and allowing connectivity for a Distribution System Operator (200) to deploy commands to offer grid services. Although five types of end-assets are presented in the depicted FIG. 1, the solution is scalable to any number of CMs (103) and combination of end-assets (1, 2, 3). The electrical supply of the HUB (100), ensured by the CSEB (400), is assumed to be 3-phased, which is the most prominent on the common services electrical board, allowing to split the available electrical power through single-phased electrical output ports, or support for 3-phased outputs is using a different hardware configuration. In the single-phase configuration the ports are internally hard-wired to default phases, avoiding the eventual bad mapping of phases in the installation process, and the three-phases are also balanced via the firmware algorithm by controlling individual loads on each of the phases. This feature can also be used by DSOs to resolve existing or momentary grid imbalances, which are very frequent in residential environments, and will increase with energy transition movement.

Moreover, the HUB (100) allows the connectivity to additional and similar HUBs, allowing further scalability, when the hardware limits (i.e. number of existent digital I/Os to control the plugs is reached or no additional physical serial communications addresses are available). Additionally, for the mentioned phase-balancing feature, the HUB (100) retrieves split-phase information from the measuring unit (401) existent at the CSEB (400) which is read through RS485 or via a HAN port, and installed as depicted in FIG. 1, giving the system visibility not only to the existing loads on the HUBs (100), but also any other existent non-monitored/managed building loads. Moreover, this information is also used to change dynamically the charge/discharge power of the managed assets, i.e., through the connection modules (103), as a function of the Maximum Admissible Power (MAP), process commonly referred in the mobility sector as dynamic smart charging.

The installation of the HUB (100) is facilitated by enabling a three-level installation protocol. First, the HUB (100) is entirely built in a production line, ensuring proper connectivity between building blocks, control over used manufacturers, device and cabling specifications; Second, it divides the accesses in different levels of electrician required skill, being the Main Compartment used for the connectivity of the HUB (100) to the CSEB (400) and/or to another HUB (100), both for power and communications, and since it is less straight forward installation, requires a higher level of specialization, which are more difficult to have access to. As for the installation of an EV charger (10, 20, 30), a custom box using a quick fix mechanism (1033) is used to grant the connectivity of both communication (1032) and power (1031) to the output ports, which are accessible in the CP Installer Compartment (1021), as depicted in FIG. 10, granting a simplified installation procedure, which can be conducted by any ordinary electrician. The Control and Comms Compartment (101, 102), is sealed, preventing the controller, communication connections and other from being tampered, which could cause malfunctioning of the system, and/or affecting the correct and precise billing of each connection module (103) the energy consumptions.

This custom construction combination of the HUB (100) overcomes one of the highlighted blockers for the EV charging infrastructure massification, by standardizing building infrastructure adaptation, avoiding the upscale of the current electrical infrastructure, simplifying the process of electrification and communications network required to connect the charging points, allowing to use electricians with lowest level of required skills when only additional charging point installation are required. In addition, it ensures regulation compliance by installing standardized connection modules (103) that include all required components for these kind of electrical installations, which is difficult to ensure in ad-hoc installations executed by multiple installers. These installers will have access to the interior of the HUB (100), in order to access the modules therein enclosed, and which is configured to allow it in a way that comprises several differentiated levels of access, to ensure security and ease of integration for technicians with an average level of product knowledge.

The connection modules (103) provide ease of connectivity and enable the reduction of the connected assets interconnections to the HUB (100) through the centralization of electrical power resources in a scalable manner.

The connection modules (103) are built in factory, ensuring proper connectivity between building blocks, which are inserted in a sealed enclosure, preventing metering/protections tampering, having control over used manufacturers devices and cabling specifications. The connection modules (103) are plugged in the HUB (100) using snap fits (1033) and pluggable connectors (1031, 1033), facilitating the process of wiring new assets, and standardizing and streamlining the installation process. The connection modules (103) have different versions and configurations, all being compatible with the HUB (100), allowing further customizations in terms of components, reducing the initial surplus in installed parts when a lower count of assets to manage exist.

The HUB (100) is interconnected with a Cloud Platform (300), via an internet protocol (503) and which is facilitated by using a communications router, e.g., a mobile communications module (101), that can be selected to provide at least one of a 3G/4G/5G, NB-IOT, LTE-M support, or other technically adapted for the mentioned propose. The controller module (102) is the responsible for maintaining the connectivity with the server (300), thus no specific constraints in terms of static IP and/or Access Point Name (APN) are required (which are usually a requirement in the commonly deployed systems). Additionally, the developed system allows to reduce the volume of data traffic, by filtering unnecessary transaction messages generated by the assets and/or performing data aggregation to reduce the number of communications. This feature has impact both on the necessary contracted mobile data volume, and also reduces unnecessary effort on the cloud services.

Following the shown example, to monitor and control mode 3 EV chargers (10) and mode 4 EV chargers (30), the system HUB (100) resorts to the use of OCPP (501, 502) protocols, for mode 2 EV chargers (20), i.e., plugs, the system HUB (100) relies on contactors and energy meters, and for photovoltaic and battery inverters (40, 50) and additional metering devices the system HUB (100) uses Modbus (500) RTU/TCP communication protocols. These protocols are deployed over either wired (ethernet or LyCy cables) or wireless infrastructures. For any other non-smart devices, i.e., the standard devices without an available communication physical interface for monitoring and control purposes of the charging procedure, the connection modules (i.e. CM2) connect and/or disconnect the mode 2 EV chargers (20) from the electrical grid by means of contactors.

Not only the communication, but also the operation of the HUB (100), is ensured by the controller module (102). It provides interconnection support to the asset interconnection proprietary boards (10, 20, 30, 40, 50) by means of different Connection Modules (103), which are plugged-in to the control module (102) through connector plugs. As an example, a connection module (CM2) that controls a mode 2 EV charger (20) can be configured with overcurrent protection (OCPD) and a Residual Current Device (RCD), following the regulatory conformity standards. Optionally, if bill splitting is required, an energy meter (Wh) that allows reading communications is included. To allow load management of said charger (20), a contactor (Cont) is used. The control and reading are achieved using an included physical interface (Phy) which varies depending on the asset interface, which can be either Ethernet (503), RS485 (500) and/or Digital I/Os (601).

The main control module (102) uses digital I/O (505) to act on the contactor to control a mode 2 EV charger (20), which connects or disconnects the end-asset (1) load to the grid. For monitoring purposes, the energy meter with RS485 or Ethernet port is included to enable its reading through the respective controller interface (507), allowing to provide both power and energy readings to the system HUB (100).

Mode 3 EV chargers and Mode 4 EV chargers, i.e., the wall boxes (10, 30), usually comprise TCP/IP interface (wired ethernet or wireless Wi-Fi) which can be connected or paired with the proposed system HUB (100). This enables monitoring the charger (10, 30) state, the consumed energy, instant power and also control for wall box proprietors that support it. The monitoring is achieved by either reading the charger's internal meter or, if required, by reading an optionally added meter to the connection module (e.g., MID metering certification is required). If connected to a V2G wall box (30) the HUB (100) is capable to deploy control commands to manage the power of the load and/or the injection, into the grid.

As non-smart mode 3 EV chargers lack support to any physical communication interface, or rely on closed/proprietary protocols, the connection module 2 (CM2) can add functionalities to these chargers, obtaining all the possible information using a connection module similar to the one used from the mode 2 EV chargers.

For inverters (40, 50), the system communicates using the TCP/IP interface (wired or wireless) or the RS485 port.

Furthermore, the HUB (100) is also able to read enthalpy meters, using a RS485 interface or impulse reader, enabling to improve the building energy thermal efficiency or split billing, by reading of several sensors is possible. Having this in place, in combination with inside and outside temperature information, allows the system to gradually learn the thermal building resistance, and improve the overall energy efficiency, contributing to reducing the buildings contribution in energy consumption and greenhouse gas emissions.

Additionally, subsequent HUBs (100) can be installed to scale the solution to as many assets as required, and by connecting them to the same network via ethernet the orchestration of the assets is still possible in a primary-secondary system logic architecture.

Hardware wise, in summary, the HUB (100) is enabled with the required electrical and communication infrastructure, for all the connected end-assets, functioning as a base board for the Connection Modules (103). The HUB (100), being more complex, was designed to accommodate the necessary connections to be performed in dedicated locations, made accessible only to electricians with different levels of required skills. The mandatory protections are only included in the HUB (100) at the moment of the asset (10, 20, 30, 40, 50) installation in the final premises of the users, by means of connection modules (103).

The Main Control Module (102) of the HUB (100) is programmed with a custom firmware, that consists at least of four main modules referenced as:
i) Data Bus and Control interface firmware,
ii) System firmware,
iii) HUB firmware, and
iv) Open Charge Point Protocol (OCPP) firmware.

### i) DATA BUS AND CONTROL INTERFACE MODULE FIRMWARE

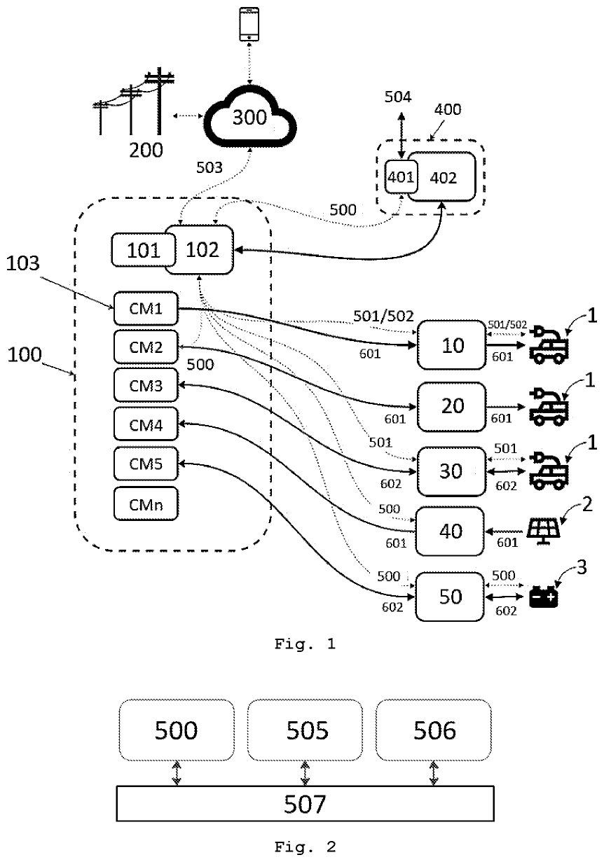

The Data Bus and Control Interface firmware, like illustrated in FIG. 2, is common to all the connection modules (103) and enables the interfacing with the controller Modbus (500), digital I/Os (505), ethernet and any other physical interfaces (506). This firmware provides access and communication between the interfaces of the remaining modules. The Data Bus & Control Interface firmware implements Modbus RTU over the RS485 port or Modbus TCP protocol over ethernet ports. This enables reading power and energy values in the seconds interval, which can then be used both for billing and ensuring that the system is working within the defined intervals. Additionally, the measuring unit (401) in the Common Services Electrical Board (400) is also read using Modbus (500) protocol. To protect the unmanaged loads, this measuring unit (401) is read in a sub-second range allowing to react prior to reach an overcurrent protection limit (sub-second range may not be achievable using the HAN Port), with their readings also being shared with the cloud platform (300). These measuring intervals and reading periodicity can be adjusted depending on the implemented use-case. The register map, for each installed asset that supports Modbus or connection module with metering capabilities (i.e. 20, 40, 50), is uploaded to the HUB (100) from the cloud (300) in a JSON format on the initial commissioning process.

### ii) SYSTEM MODULE FIRMWARE

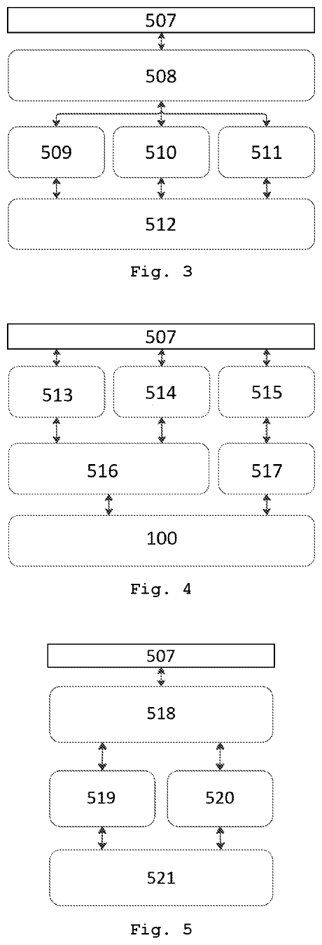

The system firmware, like illustrated in FIG. 3, coordinates the loading of system variables from the Data Bus & Control Interface (507), constants, and initialization of logging instances. As the system operates independently of the internet connection, it is able to maintain all the capabilities even in case of communications failure, a feature that is not present in all electrical vehicle chargers, which commonly become inoperative in these situations. Furthermore, it is also able to store all the relevant information locally, with this data being streamed to the cloud (300) when network connectivity is recovered. This is highly relevant to allow the billing settlement afterwards the charging procedure and also to log event errors for ease of troubleshooting.

### III) HUB MODULE FIRMWARE

The Hub module firmware, as illustrated in FIG. 4, is the most important module, and manages the supervision of the connected end-assets (1, 2, 3), wall boxes (10, 20, 30) and other assets via the communication modules (103). It manages the process of data acquisition from the charging points, including formatting it and making it a variable for usage of other existing firmware modules. It also manages the firmware update process (514) when the firmware update command is received. The HUB module firmware also launches an asset management algorithm module (517) that works independently. Lastly, it manages packages for data acquisition and control actions which is needed by other modules and internal packages.

Currently, there are four typical use-cases of algorithms to manage the EV charging loads:
1. STATIC CHARGING POINT (CP) MANAGEMENT, when a static power value is allocated to each EV charger, in order that the total sum value does not surpass the maximum value. For this use-case there is no need of monitoring any building loads.
2. DYNAMIC CP MANAGEMENT BASED ON ELECTRIC INFRASTRUCTURE CONSTRAINTS; each CP charging power is dynamically changed to avoid surpassing a maximum static total power value. For this use-case the knowledge of the charging power of each EV is mandatory, if external loads exist (i.e., elevators), the instantaneous monitoring of the total load power of the feeding electrical board for mobility is required.
3. DYNAMIC CP MANAGEMENT BASED ON THE ELECTRIC INFRASTRUCTURE AND STATIC POWER TARIFF, as in previous use-cases, and considering the energy tariffs, being the maximum instantaneous power monitored to avoid surpassing the contracted power import value and cause an energy interruption (in Portugal, Spain and others, single power tariff schemes are very common).
4. DYNAMIC CP MANAGEMENT CONSIDERING THE ELECTRIC INFRASTRUCTURE AND ENERGY TARIFFS, considering that the power import capacity tariff is calculated for the following 12-months (or other period) based on the maximum average of a 15-minutes period, and is independent of the energy consumption. In this use-case the average 15 minutes power is constantly monitored, and the loads managed accordingly to avoid increase in charging costs or additionally for time-of-use optimization, the system modulates the maximum power based on the current energy tariff cost to reduce the overall energy bill.

In the proposed invention, the smart charging and load balancing algorithms can be used in standalone mode, or as a fallback from when communication with the cloud (300) fails, since it is flexible and configurable to cope with all the mentioned smart charging use-cases.

For delivering some of the use cases the algorithm consists of constantly monitor the margin between the CSEB (400) loads, including unmanaged building loads and the HUB (100) itself, and the Maximum Allowable Power at the grid point. While there's room to accommodate additional electrical loads, the system only collects and reports the measured electrical values. When the total load reaches the maximum allowable power, the system HUB (100) acts on the managed assets (10, 20, 30, 40, 50), via the connection modules (103) to reduce it back to the admissible range. This management of electrical loads is performed in a phase aware manner, maintaining the phase imbalances within a pre-set range. The HUB (100) does not only manage the global limitation in the grid connection point, but can also manage local constraints, in a scenario when several hubs are installed, and the feeding points of each hub (100) is different.

As in the following scenario example, a two-floor garage with partial electrical boards fed by the CSEB (400), which supplies the lighting, pumps, and garage doors of each floor. If two HUBs (100) are installed, one per floor and connected to the correspondent partial switch board, in this situation the algorithm has to be aware of power limitations at two levels, one global in the CSEB (400) and locally per floor. Although it could be done using static limits without the need of additional measuring instrumentation, the proposed HUB solution (100) copes with additional measuring units and, in the prior case, one per floor could be used to enable, once again, load balancing and smart charging algorithms per floor.

The HUB firmware allows the selection between three built-in management algorithms, that can be used to deliver any of the mentioned use-cases:
a) Time-based FIFO,
b) Energy-based FIFO, and
c) Mixed smart charging.

Additional algorithms or algorithms customizations can be added.

### A) TIME-BASED FIFO ALGORITHM

The time-based FIFO algorithm, like illustrated in FIG. 6, consists of suspending the electrical power supply to a required number of electric vehicles, enabling the system load to an allowable electrical power and, while under the mentioned power supply restrictions, the system iterates (swaps active charging vehicles by suspended charging vehicles) at a preset time-interval, waiting time, between the charging and suspended vehicles in a first-in-first-out manner.

The available power refers to the clearance gap of the Maximum Available Power (MAP) that can be used for mobility, and varies in time depending on external electrical loads, and at any point in time is mentioned when a given Charging Point (CP), or asset (10, 20, 30), is “ON” for charging or “OFF” for suspended. In this case, there is only simultaneous charging if the combined power of all the charging points is inferior to the available power.

### B) ENERGY-BASED FIFO ALGORITHM

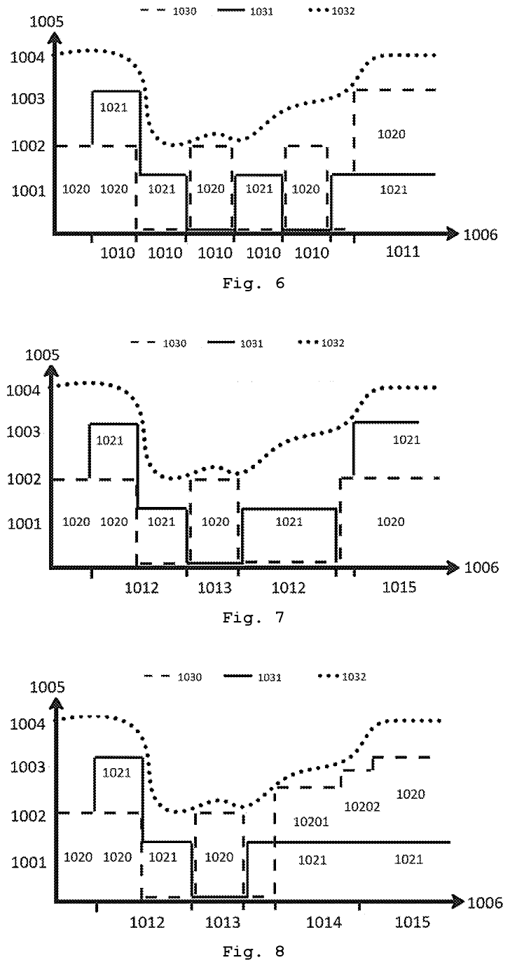

Since it is possible to have a mix of mode 2, mode 3 EV and mode 4 charging points (10, 20, 30) that have different charging powers, a second algorithm is deployed to democratize the power sharing. Instead of iterating in a time-interval, it iterates when a given amount of energy is delivered to each of the charging vehicles (1) in its' “ON” interval. This way, independently of the type of used charger, the same amount of energy is charged to the vehicle (1). As depicted in FIG. 7, when there is no available power for the Charging Points (CP) to be able to charge simultaneously, the system HUB (100) iterates between the electric vehicles (1) whenever a given amount of energy is delivered to the EV battery, in the illustrated example 1 kWh is considered. Since CP2 (1021) charges at half the power of CP1 (1020), when it is allowed to charge, it charges for twice the time as of CP1 (1020). Whenever the system has once again enough available power, both Charging Points (CP) are allowed to charge continuously and simultaneously.

### C) MIXED SMART CHARGING ALGORITHM

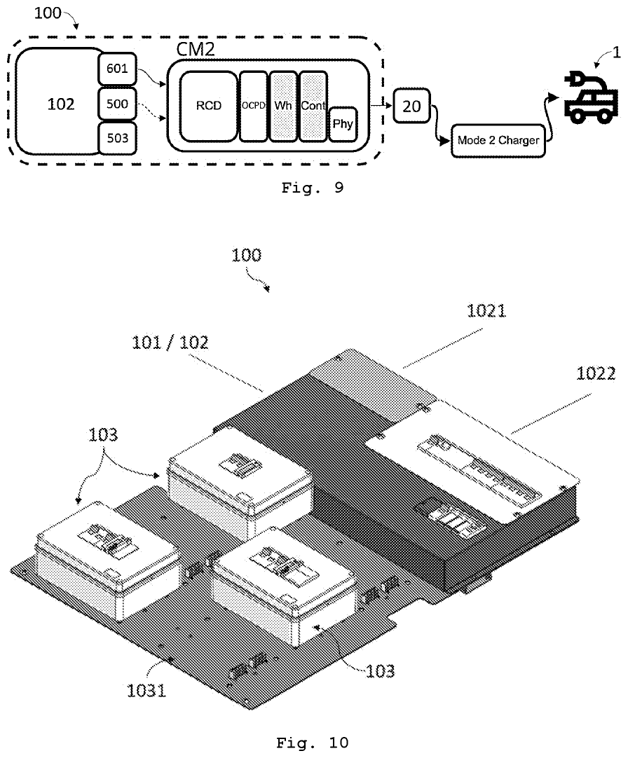

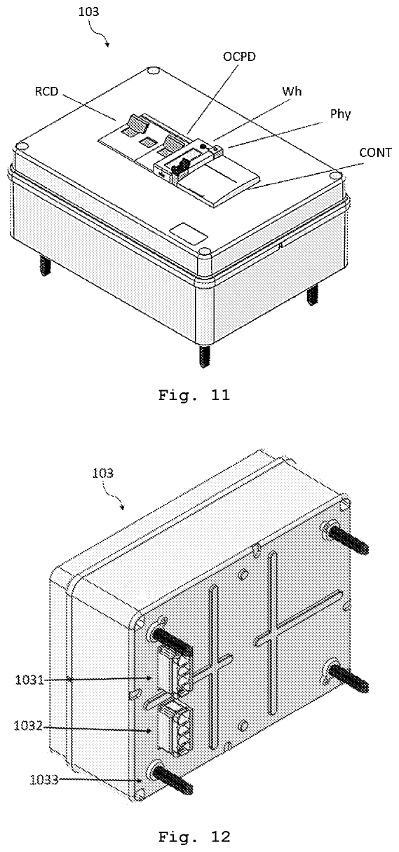

Finally, the mixed smart charging algorithm like depicted in FIG. 8 consists of reducing dynamically the mode 3 (10) and mode 4 EV Chargers (30) charging power, moving to one of the above algorithms when the minimum power setting of 2.3 kw (10 A) is reached for all the mode 3 EV chargers. As shown in the FIG. 8, CP1 (1020) is suspended on the first available power dip, since there isn't enough power for charging at half of its power, considered as 2.3 kW in the example, so the system starts to implement the energy-based Time FIFO. Only when there's room to fit half the power of CP1 (1020), it is allowed to charge, and its power increases in a stepped manner following the available power increase.

These algorithms are deployed in a local controller module enabled with processing capabilities, while allowing to explore the available electric power fully and permanently, since latency is drastically reduced to a minimum when compared to a cloud management platform. In any case, if more complex algorithms are required, they can be deployed in cloud and the commands can be streamed to the local controller, which executes them accordingly per CP. Furthermore, having visibility over inverters (40, 50), which can be fed by photovoltaics (PV), the available power can be reduced/increased accordingly to power surplus to improve the site self-consumption. For example, when that surplus is identified by the HUB (100), the available power increases, allowing more vehicles (1) to charge simultaneously or charge at higher electrical power, thus avoiding injection. When there is no surplus, the power returns to a reduced setting. In addition, the tariff plan can be uploaded to the device and the available power can be modified depending on the current tariff period, since long duration charges are envisioned, which will cross multiple tariff periods.

In a situation where there aren't power limitations the available power for charging can be lowered in the peak tariff periods, reducing the amount of energy consumed during that period, while the power limit can be removed in the off-peak hours, allowing more energy to be imported, thus reducing the final average energy consumed costs. Using this reasoning, the smart charging algorithm will only work during the peak periods, where the tariff is higher, in extreme cases all the charging's sessions can also be suspended in this period. For this tariff aware logic, after introducing the tariff plan in the system, conditions can be set to activate the smart charging functionalities, applying the previously identified algorithms, or allow unrestricted charge in defined periods.

### IV) OCPP FIRMWARE

The OCPP firmware diagram like illustrated in FIG. 5 does the setup for the OCPP server to manage locally connected mode 3 (10) mode 4 (30) EV chargers and a client instance for communicating with a remote system independently. It provides the library for OCPP message validation received from wall boxes and remote systems. To communicate with mode ¾ EV chargers (10, 30), the main controller module (102) is implemented both in OCPP 1.6 and OCPP 2.0 Protocols (501, 502), detecting the correct OCPP format directly from interfacing with the charger. The received messages are then validated and formatted, if required, to the correct remote server OCPP version, allowing the integration with any mobility platforms. Other protocols can also be deployed (i.e. MQTT), depending on the remote server integration requirements. Additionally, the platform can be integrated with billing (wallet) systems, for seamless bill settlement and/or connected to a DSO platform enabling the usage of the EV batteries for grid services, both as load management as well as demand response in the case of V2X charging stations.

The OCPP firmware module is then prepared to receive and stream the charger metering values at the charger periodicity and detects and reacts to Start/Stop transaction events. Additionally, Remote Start/Stop actions can be issued as well as preset charging profiles, as well as authentication mechanisms. In addition, OCPP protocol commands can be deployed as required as well as support to new versions, i.e. OCPP 2.0.1, depending on the application and/or use-case. Non-smart mode 3 EV chargers use the same strategy as mode 2 EV chargers to obtain the metering values and detect the start/end of charging sessions, which are translated to an OCPP format and streamed to the cloud at a preset time interval (i.e. 30 s). The detection of charging sessions is obtained using cloud authentication methods combined with the detection of changes in the power values for each individual charging point.

Although the system works autonomously, as previously mentioned, the OCPP module is capable of establish and maintain web sockets connectivity with the remote server. This is only required for remote monitoring of the system, collect and store data in a database to present in a front-end and/or to share using an API for billing settlement purposes. The backend endpoint can be freely configured for any OCPP mobility platform.

For inverters (50), the default support is for Modbus-SUNSPEC protocol. However, additional support can be deployed by uploading the corresponding inverter register map, for any given asset, to the device from the cloud in a JSON format on the initial commissioning process. Particularities of the protocol implementation in the inverter itself may require an integration process with real-live testing (i.e. timings on the refresh rate of a given command to maintain the equipment in a controllable mode). For this, the firmware driver can be customized accordingly, which, besides loading the necessary Modbus register, addresses to obtain the readings of the inverter state, and also the writes on the registers that enable the control over the inverter.

For PV inverters (40), the HUB (100) is only able to limit the power or stop the PV injection in the household grid, and, for Battery inverters, the controller manages the charge/discharge rate depending on algorithm-defined constraints. This support allows to introduce additional use-cases to an e-mobility system, such as on the so-called PV+EV current offers, and also Time-of-Use (TOU). This logic is implemented for V2X chargers and can be extended to batteries or PVs.

In resume, the proposed invention discloses an energy Management system for multi-family homes, offices and commercial buildings, helping to reduce energy costs and taking advantage of future revenue opportunities (flexibility/demand response), through local metering that enables to understand the local energy patterns at any given moment, and allows to optimize the energy usage accordingly. It conveys a Smart Charging and Load balancing using mode 2 Chargers (plug), mode 3 chargers, mode 4 chargers or all simultaneously, and interoperability allowing compatibility to any existing EVSE, Inverter, battery manufacturers. Provides an enabled Fog computing (based on Edge computing plus Cloud computing) with reduced latency between devices while reducing bandwidth requirements. More versatility by taking advantage of cloud computing central insights out to edge devices where they can be used.

The proposed solution is “virtually” agnostic to any asset that supports the available physical interfaces and orchestrates the flows of energy accordingly to defined constraints, that can have origin locally from metering devices and/or remotely from the user, cloud platform or DSO.

1. A system for managing the distributed electrical power resources of an electrical infrastructure including vehicle charging systems, comprising
a HUB connected to a Common Services Electrical Board by means of electrical wiring and MODBUS RTU/TCP communication protocols, and to a cloud platform by means of a TCP/IP communication protocol;
wherein the HUB is configured to monitor and limit distributed electrical power resources, avoiding upscaling of the electrical infrastructure, enabling the reduction of asset interconnections to said HUB through the centralization of said distributed electrical power resources in a scalable manner, said assets comprising at least one isolated proprietary electrical board for charging electrical vehicles and/or an electrical power inverter and/or an electrical distributed energy resource.

2. The system according to claim 1, wherein the Common Services Electrical Board comprises at least of a measuring unit and a main board; the measuring unit being configured to measure electrical quantities and/or grid quality metrics.

3. The system according to claim 1, wherein the HUB comprises at least a mobile communications module, a main control module and a set of connection modules, said control module being configured to monitor the electrical power resources supplied by the Common Services Electrical Board composed by managed and unmanaged electrical loads, and to
ensure the connectivity to the cloud platform, managing to log a HUB system state in a remote database therein comprised, providing to an end-user and to a platform manager the charging state of the vehicle charging system and any occurring system error.

4. The system according to claim 1, wherein the HUB is configured to enable mobile data communications and ease of power connectivity and enable both remote and local control management for all the electrically connected assets through dedicated connections provided by the set of independent Connection Modules.

5. The system according to claim 4, wherein the Connection Modules comprise multiple physical interfaces to cope with a multiplicity of assets and multiple open or custom communications protocols and the required conformity electrical protections.

6. The system according to claim 5, wherein the Connection Modules comprise at least one of an overcurrent protection device and/or a residual current device and/or measuring unit and/or communications unit and/or a contactor said contactor enabling an electric load management provided to the assets when in absence of other means of control.

7. The system according to previous claim 1, wherein the isolated proprietary electrical board for charging electrical vehicles comprises at least one of a mode 2 EV chargers and/or mode 3 EV chargers and/or mode 4 EV chargers.

8. The system according to claim 1, wherein the electrical power inverter comprises at least one of an electric micro-generation system, battery system and/or vehicle-to-grid systems.

9. The system according to claim 3, wherein the Connection Modules are configured to operate in accordance with a firmware module further comprised of multiple modules that enable communications, operation and supervision of the assets thereto connected.

10. The system according to claim 1, wherein the HUB is configured to communicate with a remote server, independent Connection Modules and deploy local algorithms, firmware updates, and further engage the connectivity and scalability to adjacent HUBs.

11. The system according to claim 3, wherein the main control module is configured to operate in accordance with a firmware setting comprised of at least one of a Data Bus and Control Interface firmware module, a System firmware module, a HUB firmware module and an Open Charge Point Protocol firmware module, the HUB firmware module being configured to enable an asset management algorithm module comprising smart charging and load balancing algorithm module that manages the maximum admissible electrical power delivered to each isolated proprietary electrical board.

12. The system according to claim 11, wherein the smart charging and load balancing algorithm module comprises at least one of a set of time-based FIFO settings module, an Energy-based FIFO settings module, and a mixed smart charging settings module, wherein
the time-based FIFO settings module is configured to suspend the electrical power supply to a required number of isolated proprietary electrical boards, enabling the overall electrical infrastructure load to an allowable electrical power level while iterating the enablement of said isolated proprietary electrical boards in a first-in-first-out time-based management procedure, splitting the electrical power supply into equal time fractions;
the energy-based FIFO settings module is configured to suspend the electrical power supply to a required number of isolated proprietary electrical boards, enabling the overall electrical infrastructure load to an allowable electrical power level while iterating the enablement of said isolated proprietary electrical boards in a first-in-first-out energy-based management procedure, splitting the electrical power supply into equal energy fractions; and
the mixed smart charging settings module is configured to suspend the electrical power supply or reduce or increase the power to a required number of isolated proprietary electrical boards, enabling to maintain overall electrical infrastructure load to an allowable electrical power level while iterating the enablement of said isolated proprietary electrical boards in a variable time and power based management procedures, splitting the both the time and varying the electrical power supply into variable energy fractions while ensuring a maximum admissible power of the electrical infrastructure.

13. The system according to claim 1, wherein the HUB is structurally configured to allow the individual access to the mobile communications module, the main control module, the connection modules and/or other modules therein enclosed, by technical installers through differentiated access level means.
